(19) United States
(12) Patent Application Publication
(10) Pub. No.: US 2011/0022493 A1
(43) Pub. Date: Jan. 27, 2011

(54) Method and System for Determining a Hot Runner Component Configuration and Presenting Same to a Customer

(75) Inventors: Robert Frederick Irwin, Essex, VT (US); Stephane Corduan, Amneville (FR)

Correspondence Address: Husky Injection Molding Systems, Inc., 288 North Road, Milton, VT, 05468, US

(73) Assignee: HUSKY INJECTION MOLDING SYSTEMS LTD., Bolton, ON (CA)

(21) Appl. No.: 12/933,710

(22) PCT Filed: Apr. 20, 2009
(86) PCT No.: PCT/US09/41067

§ 371 Date: Sep. 21, 2010

Related U.S. Application Data
(60) Provisional application No. 61/047,773, filed on Apr. 25, 2008.

(51) Int. Cl. G06Q 30/00

(52) U.S. Cl. 705/26.7

(57) ABSTRACT

Embodiments of the present invention teach a method and system for determining a hot runner component configuration and presenting same to a customer. For example, a method (300) for determining a configuration of a hot runner component for use in a hot runner (100), the method (300) executable at a processing entity (212) associated with a vendor (206) of the hot runner component, the processing entity (212) being connectable over a communication network (208) to a customer computing apparatus (202) associated with a customer (204), is provided. The method (300) comprises receiving (302) an indication of a first customer parameter associated with proposed use for the hot runner (100); based on the first customer parameter, appreciating (304) a first suitability parameter; appreciating (306) a second suitability parameter; based on the first suitability parameter and the second suitability parameter, generating (308) at least one suitability recommendation for at least one choice of the hot runner component; causing (310) a list including the at least one choice of the hot runner component and the at least one suitability recommendation to be presented on the customer computing apparatus (202).

### TECHNICAL FIELD

The present invention generally relates to, but is not limited to, a molding system, and more specifically the present invention relates to, but is not limited to, a method and system for determining a hot runner component configuration and presenting same to a customer.

### BACKGROUND OF THE INVENTION

Molding is a process by virtue of which a molded article can be formed from molding material by using a molding system. Various molded articles can be formed by using the molding process, such as an injection molding process. One example of the molded article that can be formed, for example, from polyethylene terephthalate (PET) material is a preform that is capable of being subsequently blow-molded into a beverage container, such as, a bottle and the like. Other examples of the molded articles include thin-wall containers (i.e. yogurt containers, cups, etc), medical appliances and the like.

In the early days of injection molding, a single-cavity mold for producing a single molded article per molding cycle was typically deployed. Within the single-cavity mold, typically, melt would be delivered from a plasticizing unit to a molding cavity, defined within the single-cavity mold, via a sprue. With developments in the injection molding art, multi-cavity molds have been introduced with an outlook to increase the number of molded articles manufactured per molding cycle.

Typically, within the multi-cavity mold, the melt is delivered from the plasticizing unit to each of a plurality of molding cavities of the multi-cavity mold through a melt distribution network, also known to those of skill in the art, as a “hot runner”. A typical example if a hot runner is illustrated with reference to FIG. 1, which depicts a sectional view of a hot runner 100.

Structure of the hot runner 100 of FIG. 1 is well known to those of skill in the art and, as such, only a brief description thereof will be presented herein. Within the specific example being presented herein, the hot runner 100 is configured as a two-drop manifold or, in other words, the hot runner 100 can be configured to supply melt to a mold (not depicted) having two molding cavities defined therein.

The hot runner 100 comprises a backing plate 102 and a manifold plate 104. Housed between the backing plate 102 and the manifold plate 104 is a manifold 106. The backing plate 102 is coupled to the manifold plate 104 by means of a fastener 105, which can be implemented as bolt and the like. In the specific example being presented herein, an alignment member 107 is used to align the backing plate 102 and the manifold plate 104. In the specific example being presented herein, the alignment member 107 is implemented as an alignment dowel.

The hot runner 100 further comprises a guide pin 103, the guide pin 103 being configured to assist in guiding a mold (not depicted) relative to the hot runner 100, when such mold (not depicted) is being installed onto the hot runner 100, when in use in a molding machine (not depicted).

The hot runner 100 further comprises a sprue bushing 108 located within the backing plate 102 and operatively coupled thereto by means of suitable couplers (such as bolts and the like). There is also provided a locating member 109 for positively locating the sprue bushing 108 relative to an injection molding machine platen (not depicted). The sprue bushing 108 is configured to accept, in use, a stream of melt from a plasticizing unit, which is not depicted in FIG. 1, but is known to those of skill in the art.

The hot runner 100 further comprises a nozzle assembly 110 or to be more specific, two instances of the nozzle assembly 110—a first nozzle assembly 110a and a second nozzle assembly 110b, collectively being referred to herein below as the nozzle assembly 110. However, it should be expressly understood that a different number of instances of the nozzle assembly 110 can be used in other embodiments of the present invention.

Within the specific illustration provided herein, the first nozzle assembly 110a is an example of a “valve-gated implementation” and the second nozzle assembly 110b is an example of a “thermally-gated implementation”. Now, those skilled in the art will readily appreciate that this depiction is meant to be an illustration only. A typical implementation of the hot runner 100 will normally include a single style of gating.

The second nozzle assembly 110b includes a nozzle housing 112, a tip insert 114 and a tip retainer 116. Defined within the second nozzle assembly 110b is a melt channel 118, the melt channel 118 for providing a path of travel for the melt within the second nozzle assembly 110b. It should be noted that a similar melt channel 118 is defined within the first nozzle assembly 110a. The melt channel 118 converges into an internal runner network generally depicted at 119 in FIG. 1. Generally speaking, the purpose of the internal runner network 119 (including the melt channel 118) is to provide a path of travel for the melt from the sprue bushing 108 to an orifice of a molding cavity of a mold (both not depicted for the sake of simplicity, but well-known to those of skill in the art). Within this implementation, the tip insert 114 (also referred to those of skill in the art as a “hot tip insert”) is configured to regulate the flow of the melt towards the orifice of the molding cavity.

Construction of the first nozzle assembly 110a is substantially the same as that of the second nozzle assembly 110b, other than for the flow-controlling means. Accordingly, within the first nozzle assembly 110a, there is provided a valve stem 124, the valve stem 124 for regulating the flow of melt towards the orifice of the molding cavity at appropriate portions of the molding cycle. The valve stem 124 is associated with the valve stem actuator 125, which actuates the valve stem 124 between a closed position and an operating position, as is well known to those of skill in the art.

The internal runner network 119 can be implemented in many different shapes, depending on the number of cavities (not depicted) of the mold (not depicted) that the hot runner 100 is to be used with. Some examples of known shapes for implementing the internal runner network 119 include an “H” shape, an “X” shape and the like (for the avoidance of doubt, the term “shape” refers to an arrangement of various runners within the internal runner network 119).

Further provided within the manifold 106 is a heating arrangement 121, the heating arrangement 121 being configured to maintain a target temperature for the melt flowing through the associated portion of the internal runner network 119. The nozzle assembly 110 further includes a nozzle heater 122 configured to maintain a target temperature for the melt flowing through the associated portion of the melt channel 118.

In the valve-gated implementation of the hot runner 100 of FIG. 1 (i.e. within the first nozzle assembly 110a), as part of the first nozzle assembly 110a, there is also provided a manifold bushing 140. In the specific example being presented herein, the manifold bushing 140 performs a dual purpose. Firstly, it provides a diversion (or a branch) for the internal runner network 119, where the melt “diverts” or “branches off” in a direction of approximately ninety degrees. Secondly, the manifold bushing 140 houses a portion of the valve stem 124. Within the thermally-gated implementation (i.e. within the second nozzle assembly 110b implementation), the melt branches off within the manifold 106.

The hot runner 100 comprises a number of additional elements, very well known to those of skill in the art, such as a thermocouple 130 (typically located as proximate to the melt flow as possible to measure the operating temperature of the melt); an electrical connector 132 (for connecting to a source of power); a back plate cooling arrangement 134 (for performing localized cooling function, for example, to maintain the backing plate 102 in a dimensionally stable state or to provide proper operating temperature for certain components, such as O-rings, which are not separately numbered), etc.

When a converter (i.e. an entity who is using a molding machine to convert resin into molded articles) selects the hot runner 100, she needs to consider several factors, including but not limited to, cavitation of the mold, type of resin to be used, type of molded articles to be produced (thinwall, thickwall, etc.), just to name a few. A typical provider of the hot runner 100 (i.e. a vendor) will have numerous choices and combinations available for various hot runner components, depending on some of these or others parameters associated with the converter's proposed use of the hot runner. Just as an example, a given hot runner vendor (such as, for example, Husky Injection Molding Systems Ltd. of Bolton, Canada, www.husky.ca) offers a plethora of choices of types of the nozzle assembly 110, gating solutions (for example, nozzle assemblies 110 including the valve stem 124 and the valve stem actuator 125 or, alternatively, thermally-gated solutions), etc. Typically, a lengthy interaction between a representative of the converter and a representative of a hot runner vendor takes place in order to provide a particular configuration for a particular component of the hot runner 100. This results in wasted time for the converter and for additional costs for the hot runner vendor, which it may or may not be able to pass onto the converter.

There exist certain self-service tools to enable the converter to provision the hot runner 100 of her choice using computer-based or on-line solutions. Even though these solutions make an attempt at providing description of available choices to the converter as to a given configuration of the hot runner 100, they are not completely satisfactory. For example, they fail to account for a plethora of various factors that may affect selection of the hot runner 100 by the converter. Even more specifically, they fail to provide satisfactory recommendations as to the selection of the hot runner components, such as nozzle assemblies 110 and the like.

A co-owned PCT patent application bearing a publication number WO 02/10993 by Baumann et al. published on Feb. 7, 2002 discloses a complete system for the online design and purchasing of an injection molding machine apparatus is presented. At least one merchant computer is connected to at least one buyer computer over a communications network whereby a buyer can selectably design and place on order an injection molding machine apparatus. Improved means for storage and sharing of design information of the machine apparatus is presented which results in reduced fabrication cycle time and improved quality and on time delivery.

### SUMMARY OF THE INVENTION

According to a first broad aspect of the present invention, there is provided a method for determining a configuration of a hot runner component for use in a hot runner, the method executable at a processing entity associated with a vendor of the hot runner component, the processing entity being connectable over a communication network to a customer computing apparatus associated with a customer. The method comprises receiving an indication of a first customer parameter associated with proposed use for the hot runner; based on the first customer parameter, appreciating a first suitability parameter; appreciating a second suitability parameter; based on the first suitability parameter and the second suitability parameter, generating at least one suitability recommendation for at least one choice of the hot runner component; causing a list including the at least one choice of the hot runner component and the at least one suitability recommendation to be presented on the customer computing apparatus.

According to a second broad aspect of the present invention, there is provided a system comprising: a processing entity coupled, in use, via a communication network to a customer computing apparatus associated with a customer; the processing entity being associated with a vendor of a hot runner component for a hot runner, the processing entity configured to: receive an indication of a first customer parameter associated with proposed use for the hot runner; based on the first customer parameter, appreciate a first suitability parameter; appreciate a second suitability parameter; based on the first suitability parameter and a second suitability parameter, generate at least one suitability recommendation for at least one choice of the hot runner component; cause a list including the at least one choice of the hot runner component and at least one suitability recommendation to be presented on the customer computing apparatus.

According to a third broad aspect of the present invention, there is provided a method for determining a configuration of a hot runner component for use in a hot runner, the method executable at a customer computing apparatus. The method comprises receiving an indication of a first customer parameter associated with proposed use for the hot runner; based on the first customer parameter, appreciating a first suitability parameter; appreciating a second suitability parameter; based on the first suitability parameter and the second suitability parameter, generating at least one suitability recommendation for at least one choice of the hot runner component; causing a list including the at least one choice of the hot runner component and the at least one suitability recommendation to be presented on the customer computing apparatus.

According to another broad aspect of the present invention, there is provided a method for determining a configuration of a molding machine component for use in a molding machine, the method executable at a processing entity associated with a vendor of the molding machine component, the processing entity being connectable over a communication network to a customer computing apparatus associated with a customer. The method comprises receiving an indication of a first customer parameter associated with proposed use for the molding machine; based on the first customer parameter, appreciating a first suitability parameter; appreciating a second suitability parameter; based on the first suitability parameter and the second suitability parameter, generating at least one suitability recommendation for at least one choice of the molding machine component; causing a list including the at least one choice of the molding machine component and the at least one suitability recommendation to be presented on the customer computing apparatus.

These and other aspects and features of non-limiting embodiments of the present invention will now become apparent to those skilled in the art upon review of the following description of specific non-limiting embodiments of the invention in conjunction with the accompanying drawings.

### BRIEF DESCRIPTION OF THE DRAWINGS

A better understanding of the non-limiting embodiments of the present invention (including alternatives and/or variations thereof) may be obtained with reference to the detailed description of the non-limiting embodiments along with the following drawings, in which:

FIG. 1 depicts a sectional view of a hot runner 100, the hot runner 100 implemented in accordance with known techniques.

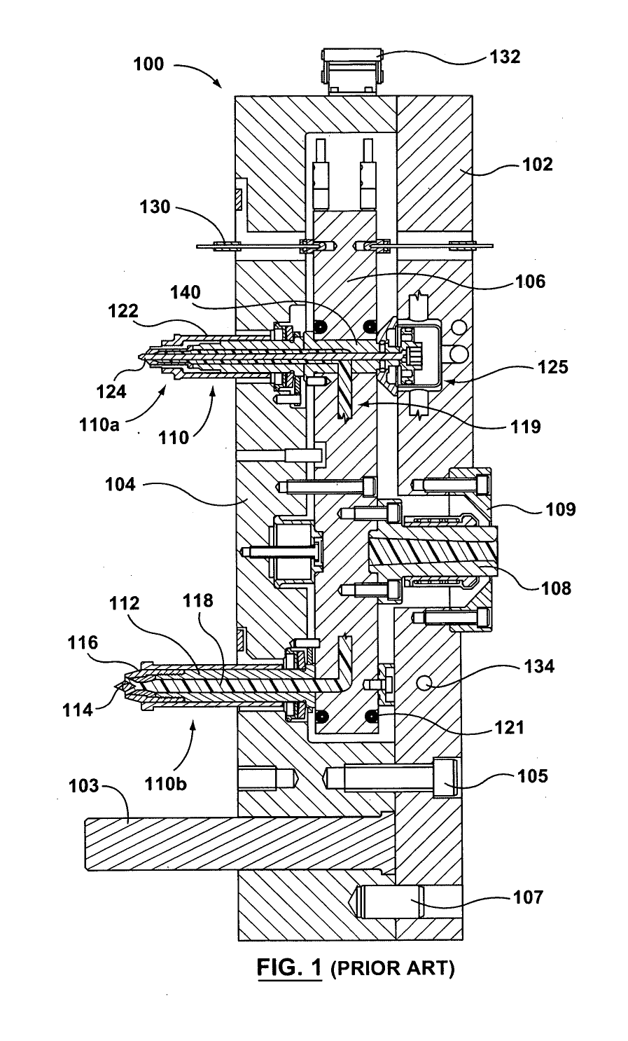

FIG. 2 depicts a system 200 for determining configuration of a hot runner component for the hot runner 100, implemented in accordance with a non-limiting embodiment of the present invention.

FIG. 3 depicts a flow chart of a method 300 executed at a processing entity 212 of the system 200 of FIG. 2, implemented according to a non-limiting embodiment of the present invention.

FIG. 4 depicts a non-limiting embodiment of a first solicitation page 400 presented to a customer during execution of the method 300.

FIG. 5 depicts a non-limiting embodiment of a second solicitation page 500 presented to the customer during execution of the method 300.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION OF THE PREFERRED EMBODIMENT(S)

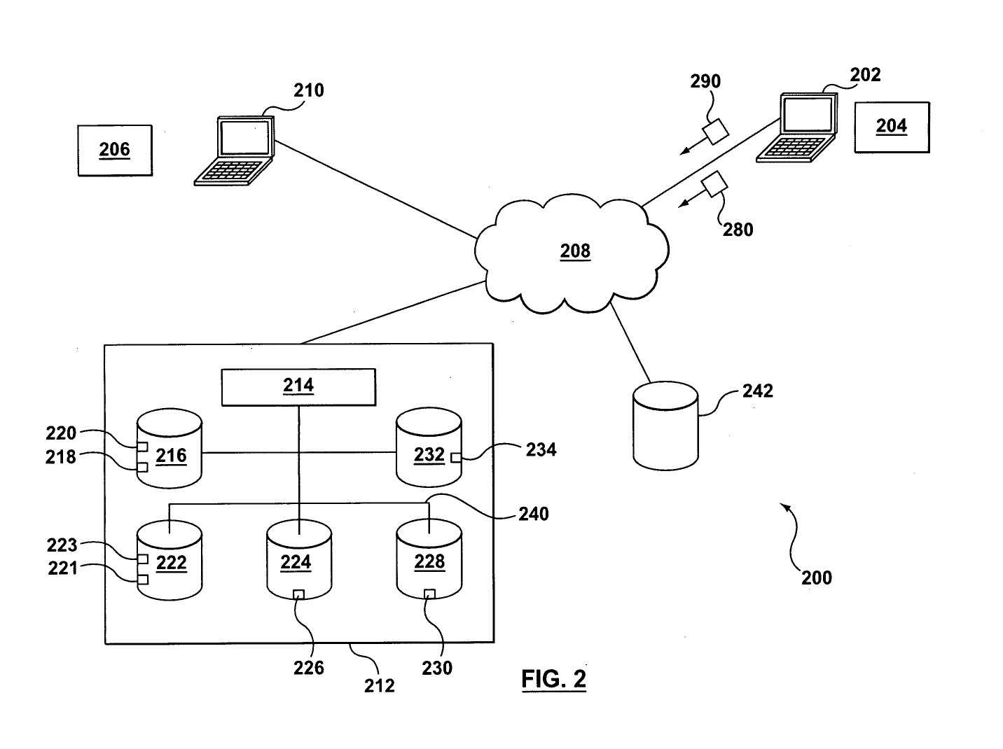

With reference to FIG. 2, there is depicted a non-limiting embodiment of a system 200 suitable for implementing non-limiting embodiments of the present invention.

The system 200 comprises a customer computing apparatus 202. The customer computing apparatus 202 is associated with a customer 204. The customer 204 is an entity that has entered into a business relationship with a vendor 206. Within the embodiments being described herein, the vendor 206 is a manufacturer and/or a supplier of molding equipment. In a specific embodiment, the vendor 206 can be a manufacturer and/or supplier of a broad range of molding equipment, such as injection molding equipment, molds, hot runners, pre-molding treatment equipment, post-molding treatment equipment, handling robots, single stage injection-blow-molding equipment, compression molding equipment and the like. An example of a vendor that manufactures and supplies at least some of these products is Husky Injection Molding System Limited of Bolton, Canada. In other embodiments of the present invention, the vendor 206 can be a manufacturer and/or supply of a particular line of products, such as, for example, manufacturer and/or supplier of molds and/or hot runners and/or components thereof.

The customer computing apparatus 202 can be implemented as a general purpose computing apparatus, as a desktop, laptop, Personal Digital Assistant (PDA), wireless hand held communication device and the like. The customer computing apparatus 202 can be coupled to a communication network 208. The communication network 208 can be implemented as a wireless network, a wired network or a combination thereof. An example of the communication network 208 can be implemented as a wide area network (such as the Internet and the like), a local area network or a combination thereof. As known to those of skill in the art, the communication network 208 can implement suitable encryption and decryption protocols for secure communication between two or more endpoints coupled to the communication network 208 (such as, for example, the customer computing apparatus 202).

Associated with the vendor 206 is a vendor computing apparatus 210, also coupled to the communication network 208. The vendor computing apparatus 210 can be associated with a salesperson of the vendor 206 or, alternatively, with a web site administrator associated with the vendor 206, or, alternatively, a web master associated with the vendor 206. Naturally, the vendor computing apparatus 210 can comprise a plurality of computing apparatuses (not depicted) associated with the vendor 206.

Also provided within the system 200 is a processing entity 212 also associated with the vendor 206. To that extent the processing entity 212 is under control and/or management of the vendor 206 and may be located at a same geographical location as the vendor 206 or, alternatively, can be located at a remote location.

Within the specific non-limiting embodiment being depicted herein, the processing entity 212 is also coupled directly to the communication network 208. However, this needs not be so in every embodiment of the present invention. For example, in alternative non-limiting embodiments of the present invention, the processing entity 212 can be coupled to the communication network 208 via a separate communication network (not depicted), via a firewalling entity and the like.

The processing entity 212 comprises a processor 214. The processor 214 can be implemented as a general-purpose or specific-purpose computing device. The processor 214 can be configured to perform various routines, for example, the processor 214 can be configured to: (a) provide interface with the communication network 208 (for example, via a modem or other suitable interfaces) and (b) coordinate functions performed by other components of the processing entity 212.

Additionally, the processor 214 comprises logic or programs to provide via the communication network 208 one or more web pages. In a sense, the processor 214 can be configured to act as a web server. To that extent, the processor 214 maintains data about one or more pages to be presented via the communication network 208. How such information is maintained is known to those skilled in the art. In a particular non-limiting embodiment, Hyper Text Markup Language (HTML) can be used, however, JAVA programming language and other suitable languages can be used. The data about one or more pages can be maintained by the web master using, for example, the vendor computing apparatus 210.

Additionally, the processor 214 can comprise internal memory, which is not depicted but is well known to those of skill in the art, and can comprise random-access memory (RAM) and the like.

The processing entity 212 further comprises a product database 216. The product database 216 maintains one or more fields configured to maintain product data 218. Product data 218 is indicative of one or more of the products provided by the vendor 206. For example, the product data 218 may contain information about one or more hot runner components (such as the nozzle assembly 110) manufactured and/or sold by the vendor 206. The product data 218 may further include cost and/or price information. Additionally, the product data 218 may include product compatibility information. For example, product compatibility information may be indicative of which hot runner component (such as the nozzle assembly 110) is compatible with what kind of use, for example, based on the type of resin to be used, etc. As another example, the product compatibility information may be indicative, which style of gating is compatible with the resin type to be used. Other examples of suitable factors affecting compatibility information will become apparent to those skilled in the art.

The product database 216 can further maintain one or more fields configured to maintain quotation data 220. Quotation data 220 includes information about one or more previously rendered quotes and, include inter alia price information, bill of material, etc.

The processing entity 212 further comprises a customer management database 222. The customer management database 222 maintains one or more fields configured to maintain customer data 223. Customer data 223 can be representative of customer-related information, such as contact details, billing information, contacts and the like associated with one or more customers associated with the vendor 206, such as for example, the customer 204. The customer data 223 can further include information representative of previous orders made by a given customer, such as the customer 204.

The customer management database 222 can further maintain one or more fields configured to maintain user data 221. User data 221 can be representative of access credentials for use with the processing entity 212 for determining a configuration of a hot runner component. In a specific example, the user data 221 comprises a user name and a password, however, other variations are also possible. The user data 221 can be associated with one or more authorized users, such as a representative of the customer 204 and the like. In certain embodiments of the present invention, a given customer (such as customer 204) may have one or more authorized users and each authorized user may get a dedicated set of access credentials stored in the user data 221 in the customer management database 222.

The processing entity 212 further comprises an Enterprise Resource Planning Database 224, which will also be referred herein below, for the sake of simplicity, as an “ERP database 224”. The ERP database 224 maintains one or more fields configured to maintain resource planning data 226. The resource planning data 226 is representative of current projects managed by the vendor 206. The resource planning data 226 may include some or all of the following: project data, bill of material data, individual component data, items in-stock, items on-order and the like.

The processing entity 212 further comprises a drawing database 228. Drawing database 228 maintains one or more fields configured to maintain drawings data 230. Drawings data 230 may include one or more engineering drawings representative of specific components delivered to customers, such as the customer 204 or components being designed by representatives of the vendor 206. Examples of drawings that can be maintained within the drawings data 230 include but are not limited to: injection machine drawings, auxiliary equipment drawings, injection unit drawings, mold drawings, mold component (ex, a neck ring or a slide) drawings, hot runner 100 drawings, hot runner component (such as the nozzle assembly 110) drawings and the like.

The processing entity 212 further comprises a customer standards database 232. The customer standards database 232 maintains one or more fields configured to maintain customer standards data 234. The customer standards data 234 is representative of design or other standards established by the customers (i.e. customer-specific standards), such as the customer 204. For example, a given customer, such as the customer 204, may have provided a list of standards to the vendor 206 and this indication is maintained within the customer standards data 234 in association with the customer 204. Examples of such standards may include things like: the type of an injection unit (two-stage, one-stage, etc.), type and design of molded articles produced (such as for example, a particular neck finish used or not used), type of gating (such as for example, valve gated or thermally gated nozzles for hot runners) and the like.

Each of the product database 216, the customer management database 222, the ERP database 224, the drawing database 228 and the customer standards database 232 is coupled to the processor 214 via an internal communication network 240. The internal communication network 240 can be implemented as a local area network, a portion of the communication network 208, a BUS connection, a parallel or a serial connection and the like.

Even though the product database 216, the customer management database 222, the ERP database 224, the drawing database 228 and the customer standards database 232 have been depicted as separate databases maintained within the processing entity 212, this needs not be so in every embodiment of the present invention. For example, in alternative non-limiting embodiments of the present invention rather than maintaining a separate database, a single database can be maintained with fields configured to maintain data as maintained within the product database 216, the customer management database 222, the ERP database 224, the drawing database 228 and the customer standards database 232 of FIG. 2. By the same token, some of the databases of the processing entity 212 of FIG. 2 can be collapsed. For example, as an alternative, the drawings data 230 can be maintained within the ERP database 224. Other variations are, of course, possible.

Finally, the system 200 may comprise an external repository 242 coupled to the communication network 208. The external repository 242 can comprise a public database (such as a web site and the like) or restricted-access or subscription-based access resource that contain information about popularity of a given hot runner component choice, discussion board about hot runner components, information about injection molding or molding industry in general, compatibility information and the like.

How the information is populated within the databases, is not particularly limited. For example, customer data 223 associated with the customer 204 can be populated when the customer 204 first contacts the vendor 206 and it can be updated as the information changes and as reported by the customer 204. Similarly, the quotation data 220 can be updated and maintained as new quotes are rendered.

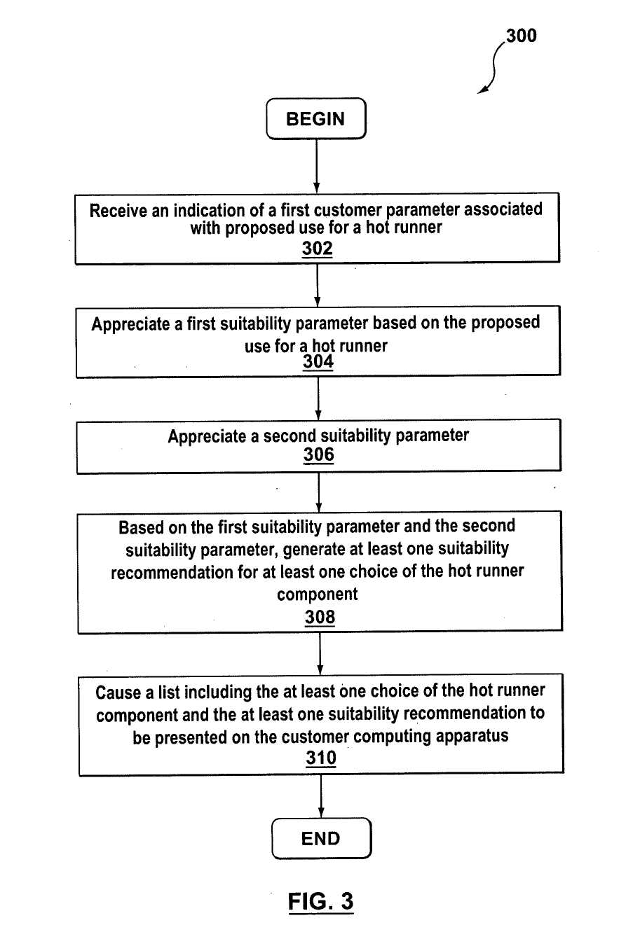

Given the system 200 of FIG. 2, it is possible to execute a method for determining a hot runner component configuration. A non-limiting embodiment of a method 400, implemented in accordance of a non-limiting embodiment of the present description, will now be described in greater detail with reference to FIG. 3. The method 300 can be conveniently executed at the processing entity 212 and, more specifically, by the processor 214. For the purposes of the description to be presented herein below, the following assumptions will be made:
(i) customer 204 has entered into a business relationship with the vendor 206 and for the purposes of the description to be presented herein below the customer 204 conducts business under a trade name “CREATIVE”;
(ii) customer 204 has been provided with access credentials for the use of the processing entity 212 and the access credentials have been properly provisioned within the user data 221 of the customer management database 222 in association with the customer 204;
(iii) customer 204 has ordered a number of hot runners 100 from the vendor 206 and information about previous orders has been stored within the customer data 223 of the customer management database 222 in association with the customer 204; and
(iv) customer 204 is desirous of acquiring another hot runner 100 from the vendor 206.
   Step 302—Receiving an Indication of a First Customer Parameter Associated with Proposed Use for the Hot Runner

Method 300 begins at step 302, where the processor 214 receives an indication of a first customer parameter associated with the proposed use for the hot runner.

The customer 204 accesses a web site associated with the vendor 206. This can be done in a conventional manner using a web application (such as Microsoft® Internet Explorer® or the like) and by typing in a Unified Resource Locator (URL) or by simply clicking on an appropriate link.

In a particular non-limiting embodiment of the present invention, the processor 214 first causes a verification page (not depicted, but well known to those of skill in the art) to be presented to the customer 204 on the customer computing apparatus 202 via the communication network 208. It will be recalled that the processor 214 can act as a web server and those skilled in the art will appreciate numerous techniques to execute the step of presenting the verification page from the processor 214 to the customer computing apparatus 202. As an example, the verification page may solicit from the customer 204 and transmit to the processor 214 a set of access credentials, such as a user name and a password. Upon receipt of the access credentials, the processor 214 accesses the customer data 223 in the customer management database 222 to verify access credentials. Should the verification fail, an appropriate error message can be presented to the customer 204. Optionally or additionally, the error message can also advise the customer 204 to call a technical support line or another representative of the vendor 206 to resolve access issues.

On the other hand, if the verification is successful, the customer 204 is granted access. In some embodiments of the present invention, successful verification of the access credentials can cause establishment of a secure communication session between the processor 214 and the customer computing apparatus 202 via the communication network 208, as is known to those of skill in the art. Alternatively, the secure communication session can be established in a separate routine.

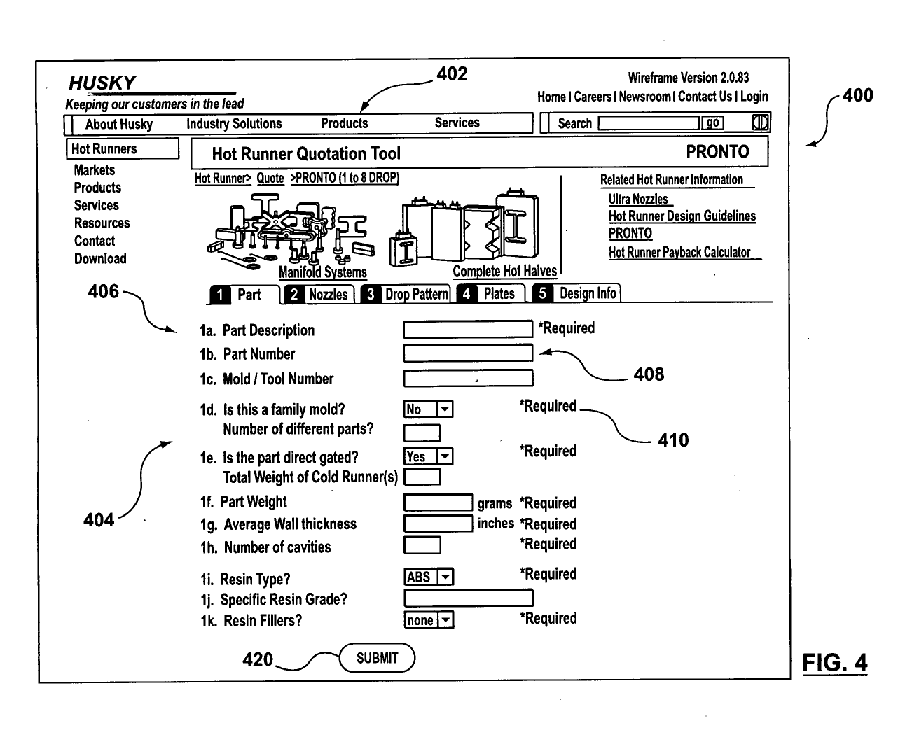

Next, the processor 214 causes a first solicitation page to be presented to the customer 204 on the customer computing apparatus 202 via the communication network 208. An example of a non-limiting embodiment of a first solicitation page 400 will now be described with reference to FIG. 4. The first solicitation page 400 contains several regions. The first solicitation page 400 comprises a first region 402, which houses identification and marketing information associated with the vendor 206, navigation pane, search pane and the like. It should be noted that configuration of and the first region 402 is an optional field and can be designed in a different manner or omitted altogether.

The first solicitation page 400 further comprises a second region 404. The second region 404 comprises solicitation information, such as questions 406 and fields for entering customer responses 408. It should be noted that the style of presenting the questions 406 and fields for entering customer responses 408 can vary.

Content of the questions 406 is designed to solicit order identification information and proposed use for the hot runner 100 information. Within the specific non-limiting embodiment being presented herein, the order identification information comprises: (a) part description, (b) part number or another unique identifier, (c) mold/tool number. It should be noted that the order identification information can contain more or fewer of these or other parameters. Generally speaking, the order identification information contains at least one parameter to uniquely identify the order. It should be noted that in alternative non-limiting embodiments, the order identification information can be pre-populated by the processor 214 rather than being entered by the customer 204.

Within the specific non-limiting embodiment of the present invention being presented herein, the proposed use for the hot runner 100 information comprises: (i) family mold information, (ii) direct gating information, (iii) weight information of the hot runner 100 being ordered, (iv) part weight information, (v) average wall thickness of the part information, (vi) number of cavities information, (vii) resin type information, (viii) specific resin grade information and (ix) use of resin fillers information. It should be noted that the potential use information can contain more or fewer of these or other parameters. Generally speaking, the potential use for the hot runner 100 information contains at least one parameter to allow first filtering of choices for the hot runner component options (for example, options for the nozzle assembly 110, etc.), as will be described herein below. For example, in alternative non-limiting embodiments of the present invention, the potential use for the hot runner 100 information may contain a parameter representative of only the type of resin used, etc.

How fields for entering customer responses 408 are implemented is not particularly limited and those skilled in the art will appreciate various alternatives, using some or all of the free text entry fields, drop-down fields, radio buttons, check buttons and the like.

It should be noted that response to certain questions 406 can be mandatory and those fields are indicated to the customer 204 as such by providing a suitable notice 410, such as “*Required” or the like.

Responses provided in the fields for entering customer responses 408 are captured and transmitted to the processor 214 via the communication network 208 in a manner well known to those of skill in the art, for example, upon the customer 204 clicking a submit button 420 or the like. More specifically, a first data element 280 (FIG. 2) is transmitted from the customer computing apparatus 202 to the processor 214 in a manner well known in the art. The first data element 280 comprises at least the order identification information and proposed use for the hot runner 100 information, as well as routing and other addressing information.

Upon receipt of the first data element 280, the processor 214 examines content thereof and, effectively, receives the indication of the first customer parameter associated with proposed use for the hot runner, at least by extracting proposed use for the hot runner 100 information from the first data element 280.

The processor 214 then proceeds to step 304.

Step 304—Based on the First Customer Parameter, Appreciating a First Suitability Parameter Associated with the Proposed Use for the Hot Runner

Then, at step 304, the processor 214 appreciates the first suitability parameter associated with the proposed use of the hot runner, based on the first customer parameter. In embodiments of the present invention, the processor 214 can generate the first suitability parameter based on the proposed use for the hot runner information received as part of step 302.

For example, the first suitability parameter can be based on the type of resin that the customer 204 is contemplating to use. Within this example, the type of resin to be used with the hot runner 100 may render certain choices of the hot runner component (ex. the nozzle assembly 110) suitable and other choices of the hot runner component (ex. the nozzle assembly 110) as not suitable.

As an example, the processor 214 accesses the product data 218 maintained within the product database 216 and, determines which hot runner component choices (for example, options for the nozzle assembly 110) are compatible with the proposed use of the hot runner 100.

An indication of suitable choices that are compatible with the proposed use of the hot runner 100 effectively becomes the first suitability parameter.

The processor 214 then proceeds to step 306.

### Step 306—Appreciating a Second Suitability Parameter

Next, as part of step 306, the processor 214 appreciates a second suitability parameter. In some embodiments of the present invention, the processor 214 receives an indication of the second suitability parameter from the customer 204.

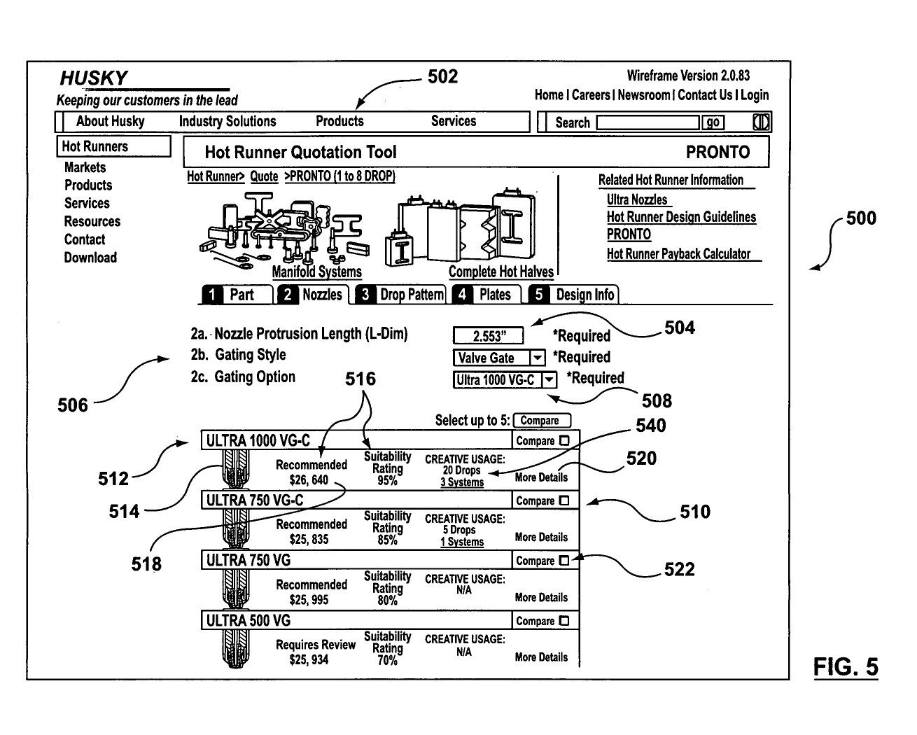

First, the processor 214 causes a second solicitation page to be presented to the customer 204 on the customer computing apparatus 202 via the communication network 208. An example of a non-limiting embodiment of a second solicitation page 500 will now be described with reference to FIG. 5.

The second solicitation page 500 contains several regions. The second solicitation page 500 comprises a first region 502, which houses identification and marketing information associated with the vendor 206, navigation pane, search pane and the like; and which can be substantially similar to the first region 402 described herein above. It should be noted that the first region 502 is an optional field and can be designed in a different manner or omitted altogether.

The second solicitation page 500 further comprises a second region 504. The second region 504 comprises further solicitation information, such as questions 506 and fields for entering customer responses 508. It should be noted that the style of presenting the questions 506 and fields for entering customer responses 508 can vary.

Content of the questions 506 is designed to solicit additional hot runner component information. Within the specific non-limiting embodiment being presented herein, the additional hot runner component information: (a) nozzle protrusion length information, (b) gating style information and (c) gating options information. It should be noted that the additional hot runner component information can contain more or fewer of these or other parameters. For example, in an alternative non-limiting implementation of the present invention, the additional hot runner component information can comprise just the nozzle protrusion length information. In other embodiments of the present invention, the additional hot runner component information may include information representative of gate vestige requirements, processing requirements (such as, for example, resin processing temperature limitations) and the like. Another example of the processing requirements is the proposed fill time. Accordingly, in alternative non-limiting embodiments of the present invention, the additional hot runner component information can include information representative of the proposed fill time required to be supported by the hot runner 100. Alternatively or additionally, the processing requirements can be representative of color change requirements and/or color change frequency required to be supported by the hot runner 100. Generally speaking, the additional hot runner component information contains at least one parameter to enable the processor 214 to provide suitability recommendations on the hot runner component choice, as will be described in greater detail herein below.

How fields for entering customer responses 508 are implemented is not particularly limited and those skilled in the art will appreciate various alternatives, using some or all of the free text entry fields, drop-down fields, radio buttons, check buttons and the like.

Responses provided in the fields for entering customer responses 508 are captured and transmitted to the processor 214 via the communication network 208 in a manner well known to those of skill in the art. More specifically, a second data element 290 (FIG. 2) is transmitted from the customer computing apparatus 202 to the processor 214 in a manner well known in the art. The second data element 290 comprises at least the further hot runner component information, as well as routing and other addressing information.

Upon receipt of the second data element 290, the processor 214 examines content thereof and, effectively, appreciates the additional hot runner component information, which can be used to derive the second suitability parameter. For example, based on the additional hot runner component information, the processor 214 can determine compatibility information of the choices contained in the list (similarly to the process described above in respect to step 304). Within these embodiments, the second suitability parameter can be said to be a customer-generated second suitability parameter.

In alternative non-limiting embodiments of the present invention, the processor 214 can appreciate the second suitability parameter in a different manner. Several alternatives are envisioned:
a. the processor 214 can appreciate the second suitability parameter by accessing the quotation data 220 maintained within the product database 216 and within this example, the second suitability parameter is based on general popularity of a given choice for the hot runner component (such as the nozzle assembly 110);
b. the processor 214 can appreciate the second suitability parameter by accessing the customer data 223 maintained within the customer management database 222 and within this example, the second suitability parameter is based on history and popularity of a given hot runner component with the customer 204;
c. the processor 214 can appreciate the second suitability parameter by accessing the customer standards data 234 maintained within the customer standards database 232 and within this example, the second suitability parameter is based on established standards associated with the customer 204;
d. the processor 214 can appreciate the second suitability parameter by accessing the external repository 242 and within this example, the second suitability parameter is based on information maintained within the external repository 242.

Naturally, the second processing parameter can be based on a combination of factors listed in (a) to (d) above. For example, in a given example of a non-limiting implementation, the second suitability parameter can be based on both general popularity of the given hot runner component choice and customer-specific popularity of the given hot runner component choice.

Within these embodiments of the present invention, the second suitability parameter can be said to be a processor-generated second suitability parameter.

In yet further non-limiting embodiments of the present invention, the second suitability parameter can be a hybrid second suitability parameter, whereby the second suitability parameter is based, in part, on information entered by the customer using the second solicitation page 500 and, in part, on information appreciated by the processor 214 as described in (a) to (d) above (or a combination thereof).

The processor 214 then proceeds to step 308.

### Step 308—Based on the First Suitability Parameter and the Second Suitability Parameter, Generating a Suitability Recommendation for at Least One Choice of the Hot Runner Component

Next, as part of step 308, based on the first suitability parameter determined as part of step 304 and the second suitability parameter determined as part of step 306, the processor 214 generates at least one suitability recommendation for at least one choice of the hot runner component.

More specifically, the processor 214 retrieves all possible choices for the hot runner component from the product data 218 maintained within the product database 216. Naturally, depending on the extent of the product line maintained by the vendor 206 for a given hot runner component, the retrieved data may have one or more of possible choices. In other words, the possible choices may contain at least one choice of the hot runner component.

The processor 214 then applies the first suitability parameter and the second suitability parameter to generate at least one suitability recommendations for the at least one choice of the hot runner component retrieved from the product data 218.

In an embodiment of the present invention, the processor 214 can generate the at least one suitability recommendation in a form of an alpha-grapheme suitability indicator. An example of an alpha-grapheme suitability indicator can be: “Recommended”, “Requires review”, “Not recommended”.

In alternative non-limiting embodiment of the present invention, the processor 214 can generate the at least one suitability recommendation in a form of a numerical suitability indicator. An example of a numerical suitability indicator can be a percentage-based suitability indicator, such as 100% suitable, 80% suitable, 60% suitable, etc.

In yet further non-limiting embodiments, the processor 214 can generate the at least one suitability recommendation as a hybrid suitability indicator. The hybrid suitability indicator can include a primary suitability indicator and a secondary suitability indicator.

In an example implementation, the primary suitability indicator can be a percentage-based suitability indicator and the secondary suitability indicator can be the alpha-grapheme suitability indicator. In a sense, the secondary suitability indicator can qualify the first suitability indicator in terms that are more easily discernable by a human. Within certain embodiments of the present invention, the secondary suitability indicator can be configured as a “slave” to the primary suitability indicator, which becomes a “master”. For example, for choices of the hot runner components that have been assigned the primary suitability indicator of over 70%, the secondary suitability indicator can be selected to be “Recommended”, for those choices that have been assigned the primary suitability indicator of between 50% and 69%, the secondary suitability indicator can be selected to be “Requires review” and the like.

The processor 214 can generate the at least one suitability recommendation for a particular choice of the hot runner component based on a weighting factor assigned to a particular one of the first suitability parameter and the second suitability parameter.

For example, in certain embodiments of the present invention, the first suitability parameter can be assigned more weight vis-à-vis the second suitability parameter. Similarly, in those embodiments of the present invention, where the second suitability parameter is a hybrid second suitability parameter based on the customer-provided input and the processor-generated input, individual components of the hybrid second suitability parameter can be assigned specific weighting factors.

For example, consider a particular scenario, where the hybrid second suitability parameter consists of (a) customer provided input (ex. nozzle protrusion length); (b) a first processor-generated parameter (ex. customer specific popularity of a given choice of the hot runner component; and (c) a second processor-generated parameter (ex. general popularity of the given choice of the hot runner component). Within this scenario, as an example only, most of the weighting factor generally attributable to the second suitability parameter can be assigned to the customer provided input. Furthermore, within this example, of the remaining weighting factor assigned to the second suitability parameter, majority can be assigned to the first processor-generated parameter over the second processor-generated parameter. Within this example, the weighting parameters clearly “favor” the customer provided input and customer-specific history of orders. By adjusting the weighting factors, the processor 214 can be directed to apply a different weighting factors in the process of generating the at least one suitability recommendation.

The processor 214 then proceeds to execution of step 310.

### Step 310—Cause a List Including the at Least One Choice of the Hot Runner Component and the at Least One Suitability Recommendation to be Presented on the Customer Computing Apparatus 202

Next, at step 310, the processor 214 can present the list including the at least one choice of the hot runner component and the at least one suitability recommendation to the customer 204.

In an embodiment, this presentation can be done using the second solicitation page 500 and, more specifically, a third region 510 thereof. In alternative non-limiting embodiments, this presentation can be executed by virtue of a separate page. The third region 510 can be used to display the list. In particular, the third region 510 can be configured to display several entries of the second rated list. Each of the entries includes an indication of the choice 512, which can be a part name or another identifier retrieved by the processor 214 from the product data 218 maintained within the product database 216. Each of the entries can further include, a figurative representation of the choice 514, which can be generated by the processor 214 based on drawings data 230 maintained within the drawing database 228.

Furthermore, each of the entries can further include an indication of a suitability recommendation 516, which in the specific non-limiting embodiment comprises the primary suitability indicator (i.e. 85% in the top entry) and a secondary suitability indicator (i.e. “Recommended” in the top entry).

Additionally, each of the entries can include an indication of a price 518 associated with the choice, which can be generated by the processor 214 from product data 218 maintained in the product database 216. Additionally, each of the entries may include a link for more details 520, which upon activation by the customer 204 can open a new page that shows additional information about the choice (such as, dimensions, suitable resins, gating style, etc.), which can be generated by the processor 214 from product data 218 maintained in the product database 216 or from resource planning data 226 maintained within the ERP database 224.

In some embodiments of the present invention, each of the entries can optionally include an auxiliary suitability indication 540. In a particular example being presented herewith, the auxiliary suitability indication 540 comprises an indication of how widely a given choice is deployed by the customer 204. The auxiliary suitability indication 540 can be generated by the processor 214 by extracting and compiling data maintained within the customer data 223 of the customer management database 222. In a specific example for the top line of the potential choices, it is indicated that the specific choice “ULTRA 1000 VG-C” has been used by “CREATIVE” 20 times in 3 systems. By the same token, the specific choice listed at a bottom line (“ULTRA 500VG”) has not been used by the customer 204. Within these embodiments, the auxiliary suitability indication 540 can be used by the customer 204 in addition to the suitability recommendation 516.

Additionally or alternatively, as part of the auxiliary suitability indication 540 (or elsewhere within the third region 510 for that matter), additional information may be presented to the customer 204. For example, the auxiliary suitability indication 540 may include an indication of the fill time interval (i.e. a supported fill time interval) that can be supported by a given choice of the hot runner component. Additionally or alternatively, the auxiliary suitability indication 540 can be representative of the type and/or frequency of color changes (for example, supported color change type, supported color change frequency, etc.) that a given choice of the hot runner component can support. Additionally or alternatively, auxiliary information 540 may comprise an indication of a delivery time for a given choice of the hot runner component.

Once the customer 204 reviews the second rated list presented in the third region 510, the customer 204 can select a given choice based on the recommendations provided by the processor 214. The selection can be made, for example, by clicking on any of the fields in a given entry (for example, on the indication of the choice 512). To assist the customer 204 in choosing between different recommendations, a compare option 522 can optionally be provided. The compare option 522 is known to those of skill in the art and allows the customer 204 to visually compare one or more of the selected options. Upon activating the compare option 522, the customer 204 is presented with tabulated information about two or more of the selected choices.

Effectively, the customer 204 has been presented with a list of hot runner component choices, including a suitability recommendation; which has enabled the customer 204 to make an educated choice of the hot runner component based on a multitude of factors, including proposed use of the hot runner, customer's preference, general preferences in the industry, specific limitations and the like.

Optionally, the processor 214 can send a copy of the list to the vendor computing apparatus 210 to be reviewed, for example, by a representative of the vendor 206 (such as, for example, a salesperson). Additionally, in case the customer 204 selects a choice that has been rated as “Requires review”, a review request can be sent by the processor 214 to the vendor computing apparatus 210 for review by engineers or customer services representatives.

Even though the foregoing description has been presented with an example of a network-implemented architecture, this needs not be so in every embodiment of the present invention. For example, in alternative non-limiting embodiments of the present invention, it is contemplated that the method 300 can be executed locally on the customer computing apparatus 202. Appropriate software can be downloaded to the customer computing apparatus 202 via an Internet connection or be installed using a CD-ROM or other suitable means. It is expected that those skilled in the art having benefit of teachings presented herein above will be able to modify the method 300 for the local implementation. In yet further non-limiting embodiments, the execution of the method 300 can be distributed—in the sense of some steps being executed locally on the customer computing apparatus 202, with the customer computing apparatus 202 accessing remote entities (such as the databases maintained within the processing entity 212, for example) via the communication network 208 for appreciating of certain data stored therein.

Even though the foregoing description has used a hot runner component as an example to demonstrate execution of the method 300, the method 300 can be equally applied to other molding machine components. For example, in an alternative execution, the method 300 can be applied to determining a configuration of a mold base, as well as other components of the molding machine.

A technical effect of embodiments of the present invention is a provision of a system that enables the customer 204 to select a hot runner component without substantial involvement of a representative of the vendor 206. Additionally, a technical effect of embodiments of the present invention includes providing a list of hot runner component choices including suitability recommendations based on a multitude of factors, including proposed use of the hot runner, customer's preference, general preferences in the industry, specific limitations and the like without substantial involvement of a representative from the vendor 206. Another technical effect of embodiments of the present invention includes provision of a self-serve system that only requires involvement of the representative of the vendor 206 to review certain choices, such as those marked as “Requires review”. It should be noted that not each and every technical effect needs to be realized, in its entirety, in each and every embodiment of the present invention.

Description of the non-limiting embodiments of the present inventions provides examples of the present invention, and these examples do not limit the scope of the present invention. It is to be expressly understood that the scope of the present invention is limited by the claims. The concepts described above may be adapted for specific conditions and/or functions, and may be further extended to a variety of other applications that are within the scope of the present invention. Having thus described the non-limiting embodiments of the present invention, it will be apparent that modifications and enhancements are possible without departing from the concepts as described. Therefore, what is to be protected by way of Letters Patent are limited only by the scope of the following claims:

What is claimed is:

1. A method (300) for determining a configuration of a hot runner component for use in a hot runner (100), the method (300) executable at a processing entity (212) associated with a vendor (206) of the hot runner component, the processing entity (212) being connectable over a communication network (208) to a customer computing apparatus (202) associated with a customer (204), the method (300) comprising:
receiving (302) an indication of a first customer parameter associated with proposed use for the hot runner (100);
based on the first customer parameter, appreciating (304) a first suitability parameter;
appreciating (306) a second suitability parameter;
based on the first suitability parameter and the second suitability parameter, generating (308) at least one suitability recommendation for at least one choice of the hot runner component;
causing (310) a list including the at least one choice of the hot runner component and the at least one suitability recommendation to be presented on the customer computing apparatus (202).

2. The method (300) of claim 1, wherein said hot runner component is a nozzle assembly (110).

3. The method (300) of claim 1, wherein said first customer parameter is representative of a type of resin to be used within the hot runner (100).

4. The method (300) of claim 1, wherein said indication of the first customer parameter further comprises a unique identifier of an order.

5. The method (300) of claim 1, wherein said first suitability parameter comprises an indication of which ones of available choices for the hot runner component are compatible with the proposed use of the hot runner (100).

6. The method (300) of claim 5, wherein said first customer parameter is representative of a type of resin to be used within the hot runner (100), and wherein said first suitability parameter comprises an indication of which ones of available choices for the hot runner component are compatible with the type of resin to be used within the hot runner (100).

7. The method (300) of claim 1, wherein said appreciating (306) the second suitability parameter comprises receiving an indication of the second suitability parameter from the customer computing apparatus (202).

8. The method (300) of claim 7, said hot runner component being a nozzle assembly (110), and wherein said second suitability parameter comprises an indication of at least one of:
a protrusion length of the nozzle assembly (110);
gating style information;
gating options information;
gate vestige requirements;
processing requirements.

9. The method (300) of claim 8, wherein the processing requirements are indicative of at least one of:
color change requirements;
color change frequency;
an indication of a proposed fill time.

10. The method (300) of claim 1, wherein said appreciating (306) the second suitability parameter comprises generating said second suitability parameter by the processing entity (212).

11. The method (300) of claim 10, wherein said second suitability parameter is based on at least one of:
general popularity of a given hot runner component choice;
popularity of the given hot runner component choice with the customer (204); and
customer-specific standards associated with the customer (204).

12. The method (300) of claim 1, wherein said appreciating (306) the second suitability parameter comprises appreciating a hybrid second suitability parameter and wherein said hybrid second suitability parameter is based on:
an indication received from the customer computing apparatus (202); and
an indication generated by the processing entity (212).

13. The method (300) of claim 1, wherein said generating (308) the at least one suitability recommendation for the at least one choice of the hot runner component comprises generating a numerical suitability indicator.

14. The method (300) of claim 1, wherein generating (308) the at least one suitability recommendation for the at least one choice of the hot runner component comprises generating an alpha-grapheme suitability indicator.

15. The method (300) of claim 1, wherein generating (308) the at least one suitability recommendation for the at least one choice of the hot runner component comprises generating a hybrid suitability indicator.

16. The method (300) of claim 15, wherein said hybrid suitability indicator comprises a primary suitability indicator and a secondary suitability indicator.

17. The method (300) of claim 16, wherein one of said primary suitability indicator and the secondary suitability indicator is a slave, and the other one said primary suitability indicator and the secondary suitability indicator is a master.

18. The method (300) of claim 1, wherein the list further comprises an auxiliary suitability indication (540).

19. The method (300) of claim 18, wherein said auxiliary suitability indication (540) is indicative of at least one of:
past use of the at least one choice of the hot runner component by the customer (204);
supported fill time interval;
supported color change frequency;
supported color change type.

20. A system (200) comprising:
a processing entity (212) coupled, in use, via a communication network (208) to a customer computing apparatus (202) associated with a customer (204); the processing entity (212) being associated with a vendor (206) of a hot runner component for a hot runner (100), the processing entity (212) configured to:
receive an indication of a first customer parameter associated with proposed use for the hot runner (100);
based on the first customer parameter, appreciate a first suitability parameter;
appreciate a second suitability parameter;
based on the first suitability parameter and a second suitability parameter, generate at least one suitability recommendation for at least one choice of the hot runner component;
cause a list including the at least one choice of the hot runner component and at least one suitability recommendation to be presented on the customer computing apparatus (202).

21. A method (300) for determining a configuration of a hot runner component for use in a hot runner (100), the method (300) executable at a customer computing apparatus (202), the method (300) comprising:
receiving (302) an indication of a first customer parameter associated with proposed use for the hot runner;
based on the first customer parameter, appreciating (304) a first suitability parameter;
appreciating (306) a second suitability parameter;
based on the first suitability parameter and the second suitability parameter, generating (308) at least one suitability recommendation for at least one choice of the hot runner component;
causing (310) a list including the at least one choice of the hot runner component and the at least one suitability recommendation to be presented on the customer computing apparatus (202).

22. A method (300) for determining a configuration of a molding machine component for use in a molding machine, the method (300) executable at a processing entity (212) associated with a vendor (206) of the molding machine component, the processing entity (212) being connectable over a communication network (208) to a customer computing apparatus (202) associated with a customer (204), the method (300) comprising:
receiving (302) an indication of a first customer parameter associated with proposed use for the molding machine;
based on the first customer parameter, appreciating (304) a first suitability parameter;
appreciating (306) a second suitability parameter;
based on the first suitability parameter and the second suitability parameter, generating (308) at least one suitability recommendation for at least one choice of the molding machine component;
causing (310) a list including the at least one choice of the molding machine component and the at least one suitability recommendation to be presented on the customer computing apparatus (202).
